(19) United States
(12) Patent Application Publication
(10) Pub. No.: US 2015/0202692 A1
(43) Pub. Date: Jul. 23, 2015

(54) Chuck

(71) Applicants: Chi-Kuo Lin, Taichung (TW); Chi-Wen Lin, Taichung (TW)

(72) Inventors: Chi-Kuo Lin, Taichung (TW); Chi-Wen Lin, Taichung (TW)

(21) Appl. No.: 14/676,813

(22) Filed: Apr. 2, 2015

(51) Int. Cl. B23B 31/173

(52) U.S. Cl. CPC B23B 31/16158

(57) ABSTRACT

A device includes a rear holding member including a front externally threaded projection and a varied-diameter passage; a flexible clamping member including a conic section, a rear tapered section, and an axial channel; a retainer ring including an inwardly extending annular member and an internally threaded section; a front holding member including a rear flange, a front conic passageway, and internal threads; and a fastening ring including rear threads, an internal shoulder, and two front, opposite curved members. The clamping member is urged against the passage; the retaining ring is put on the rear holding member; a drill bill is configured to insert through the channel into the passage; the front holding member has a rear end urging against the annular member; the internal threads are secured to the externally threaded projection, and an inner surface of the front holding member compresses the conic section.

### BACKGROUND OF THE INVENTION

1. Field of the Invention

The invention relates to chucks and more particularly to such a chuck adapted to cooperate with a device for calibrating a drill bill of the chuck.

2. Description of Related Art

Devices for calibrating a drill bill of a chuck are well known. However, the drill bill is not precisely calibrated after being calibrated by the device. This is because the clamping mechanism of the chuck is disadvantageous. Thus, the need for an improved chuck exists.

### SUMMARY OF THE INVENTION

It is therefore one object of the invention to provide a chuck comprising a rear holding member including a front externally threaded projection and a varied-diameter passage; a flexible clamping member including a conic section having a plurality of longitudinal slits, a rear tapered section, and an axial channel; a retainer ring including an inwardly extending annular member and an internally threaded section; a front holding member including a rear flange, a front conic passageway, and internal threads; and a fastening ring including rear threads, an internal shoulder, and two front, opposite curved members; wherein the clamping member is urged against the passage; the retaining ring is put on the rear holding member; a drill bill is configured to insert through the channel into the passage; the front holding member has a rear end urging against the annular member; the internal threads are secured to the externally threaded projection, and an inner surface of the front holding member urges against and compresses the conic section.

The above and other objects, features and advantages of the invention will become apparent from the following detailed description taken with the accompanying drawings.

### BRIEF DESCRIPTION OF THE DRAWINGS

FIG. 1 is an exploded view of a chuck according to the invention;

FIG. 2 is a perspective view of the chuck to be mounted with a drill bill;

FIG. 3 is a longitudinal sectional view of the assembled chuck and the drill bill;

FIG. 4 is a view similar to FIG. 3 with a positioning device mounted thereon;

FIG. 5 is a perspective view of the chuck mounted with the drill bill to be joined a calibration device;

FIG. 6 is a front view of the assembled chuck, the drill bill, and the calibration device showing a calibration operation of the drill bill; and

FIG. 7 is a perspective view of a grinding machine for grinding a drill bill mounted on the chuck.

### DETAILED DESCRIPTION OF THE INVENTION

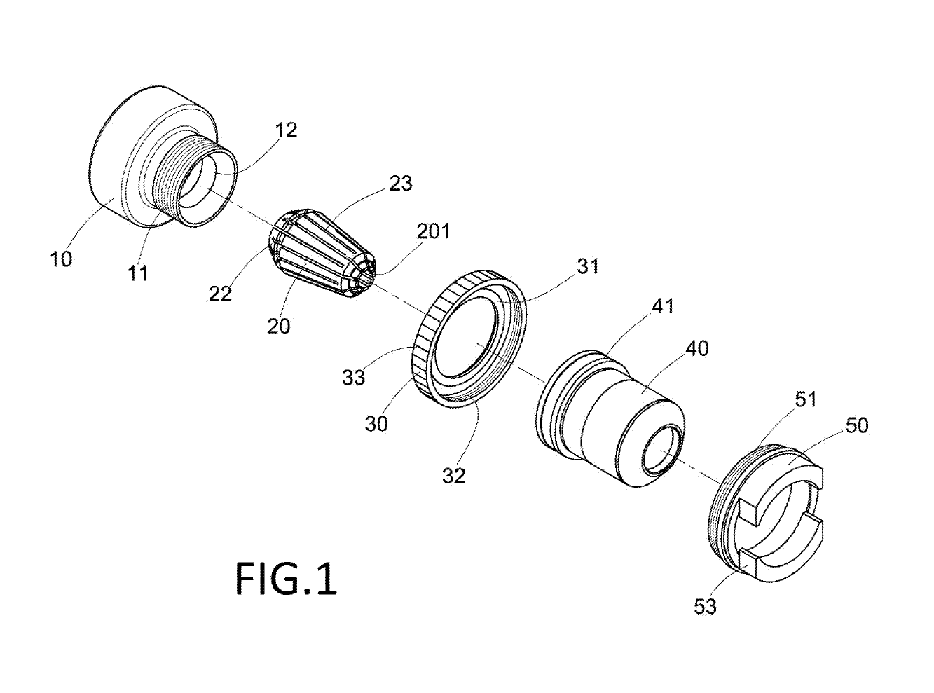

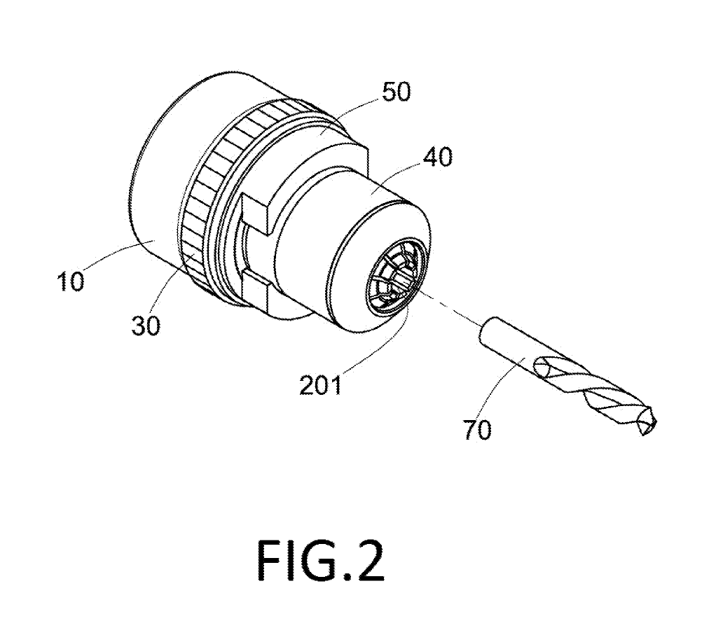

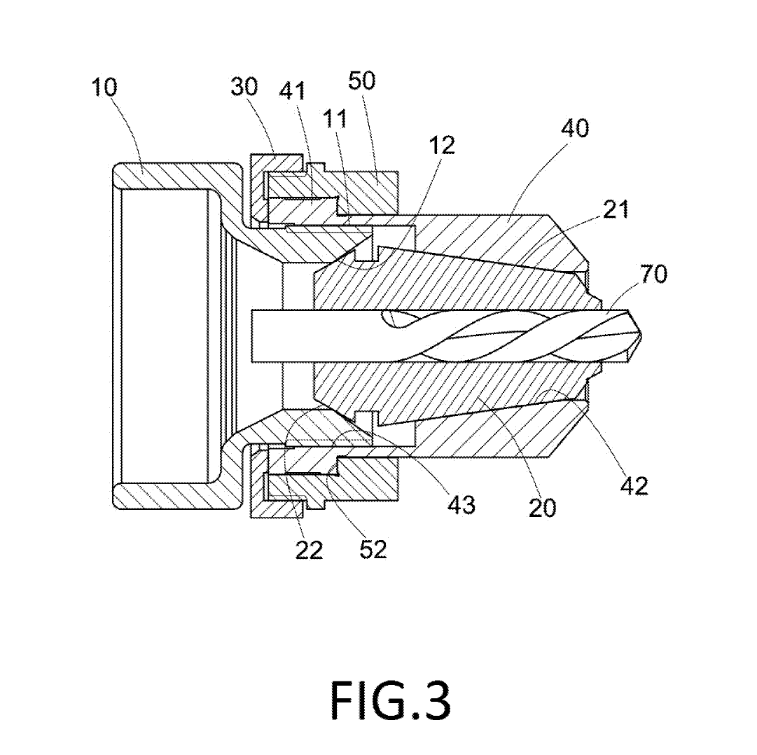

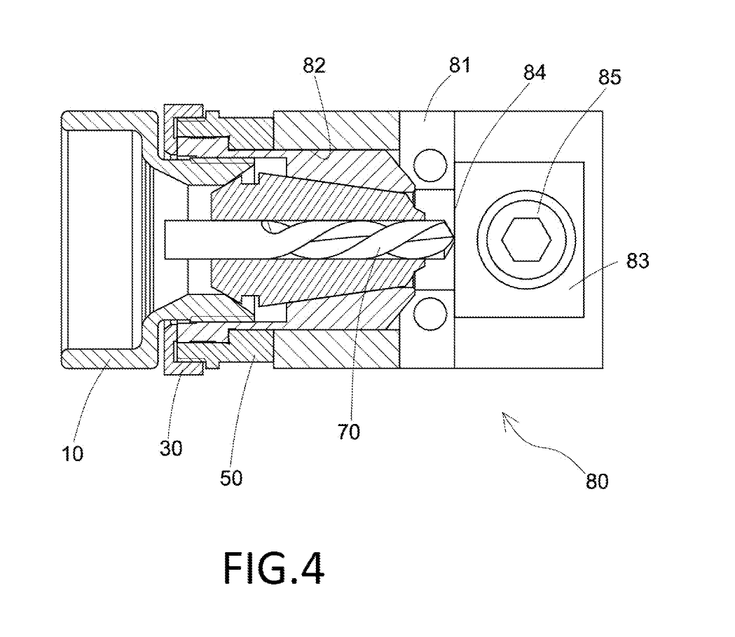

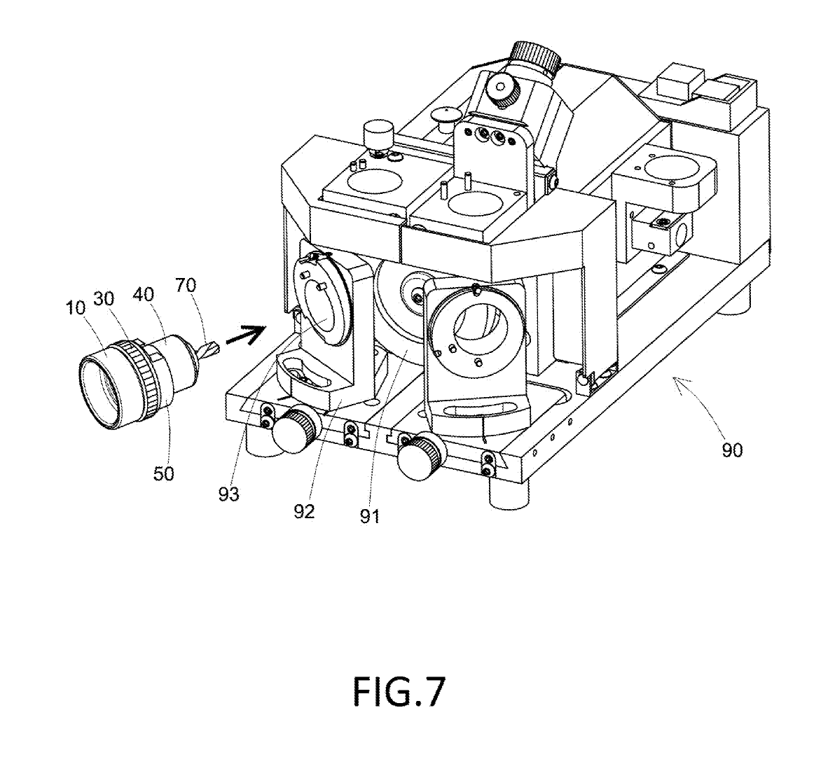

Referring to FIGS. 1 to 7, a chuck in accordance with the invention comprises the following components as discussed in detail below.

A rear holding member 10 includes a front externally threaded projection 11 and a varied-diameter passage 12. A flexible clamping member 20 includes a conic section 21 having a plurality of longitudinal slits 23, a rear tapered section 22, and an axial channel 201. A retainer ring 30 includes an inwardly extending annular member 31, an internally threaded section 32, and an annular knurled member 33 on an outer surface. A front holding member 40 includes a rear flange 41, a front conic passageway 42, and internal threads 43 rearward of the conic passageway 42. A fastening ring 50 includes rear threads 51, an internal shoulder 52, and two front opposite curved members 53. A calibration device 60 includes an intermediate sleeve 61, a front window 62, a calibrating line 63 on the window 62, and a rear curved element 64. A positioning device 80 includes a seat 81, a hole 82 in the seat 81, a block member 83 opposite to the hole 82, an urging surface 84, and a bolt 85 for securing the block member 83 to the seat 81.

The clamping member 20 is urged against the passage 12. The retaining ring 30 is put on an intermediate portion of the rear holding member 10. A drill bill 70 has a rear end inserted through the channel 201 into an intermediate portion of the passage 12. The front holding member 40 has a rear end urging against the annular member 31, the internal threads 43 are secured to the externally threaded projection 11, and inclined inner surface of the front holding member 40 urges against and compresses the conic section 21. The front holding member 40 is inserted into the hole 82 until the fastening ring 50 is stopped by the seat 81 and the tip of the drill bill 70 is stopped by the urging surface 84. The rear holding member 10 is rotated to fasten the drill bill 70 in the conic section 21. Finally, the chuck and the drill bill 70 are detached from the positioning device 80.

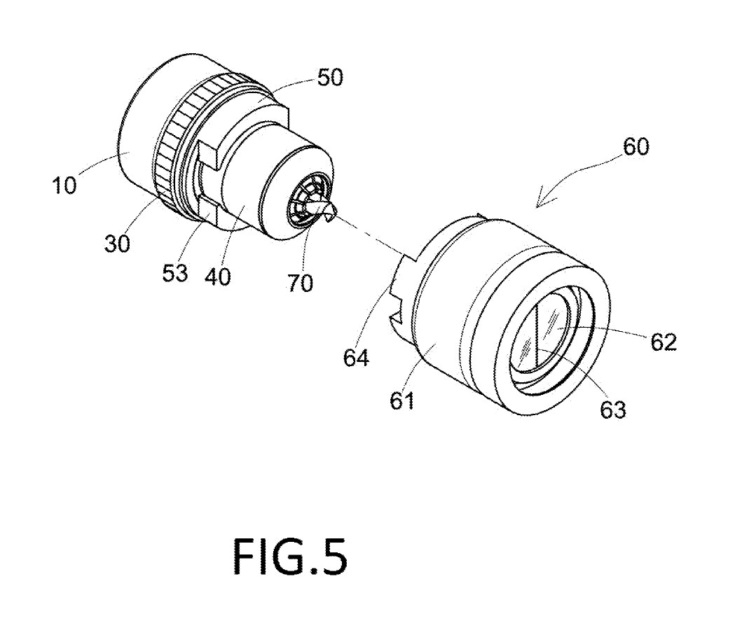

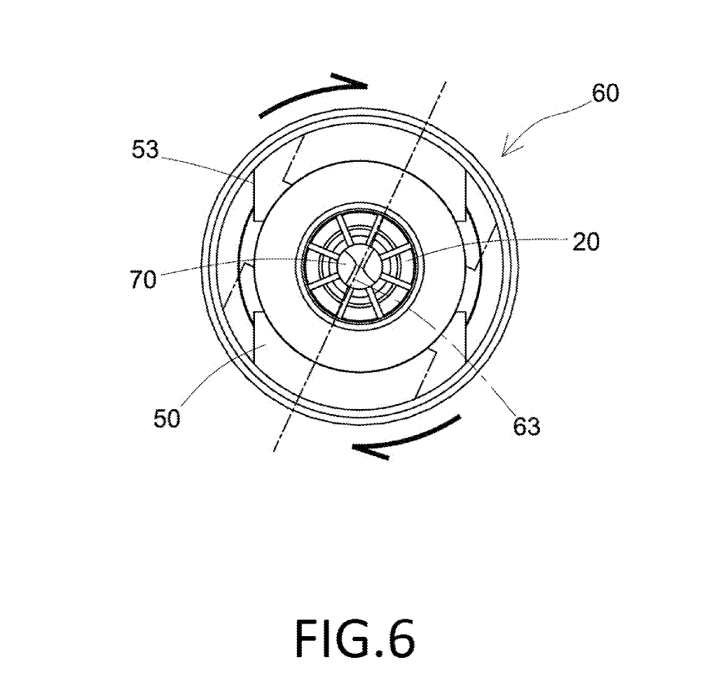

As shown in FIGS. 5 and 6, in a calibration operation, the curved element 64 is inserted into a gap between one ends of the curved members 53. The retainer ring 30 is loosened. A user may view through the window 62 to check whether the drill bill 70 is aligned with the calibrating line 63. The user may rotate the rear holding member 10 to rotate the drill bill 70 for alignment if the drill bill 70 was not aligned with the calibrating line 63. Finally, the user may fasten the retainer ring 30.

In a grinding operation, the chuck and the drill bill 70 can be partially inserted into a hole 93 of one of two seat members 92 of a grinding machine 90. The user may activate an abrasive wheel 91 to grind the drill bill 70.

While the invention has been described in terms of preferred embodiments, those skilled in the art will recognize that the invention can be practiced with modifications within the spirit and scope of the appended claims.

What is claimed is:

1. A chuck comprising:
a rear holding member including a front externally threaded projection and a varied-diameter passage;
a flexible clamping member including a conic section having a plurality of longitudinal slits, a rear tapered section, and an axial channel;
a retainer ring including an inwardly extending annular member and an internally threaded section;
a front holding member including a rear flange, a front conic passageway, and internal threads; and
a fastening ring including rear threads, an internal shoulder, and two front, opposite curved members;
wherein the clamping member is urged against the passage; the retaining ring is put on the rear holding member; a drill bill is configured to insert through the channel into the passage; the front holding member has a rear end urging against the annular member; the internal threads are secured to the externally threaded projection, and an inner surface of the front holding member urges against and compresses the conic section.
